(19) United States
(12) Patent Application Publication
(10) Pub. No.: US 2006/0207514 A1
(43) Pub. Date: Sep. 21, 2006

(54) Dog travel tubes

(76) Inventor: Chad Logan, Seal Beach, CA (US)

Correspondence Address: JAMES RAY & ASSOCIATES, 2640 PITCAIRN ROAD, MONROEVILLE, PA, 15146, US

(21) Appl. No.: 11/370,787

(22) Filed: Mar. 8, 2006

Related U.S. Application Data
(60) Provisional application No. 60/663,571, filed on Mar. 18, 2005.

(51) Int. Cl. A01K 5/01

(52) U.S. Cl. 119/61.56

(57) ABSTRACT

An apparatus for assisting in one of traveling and taking extended walks with a pet. The apparatus comprises at least one elongated member having each of a predetermined cross section and a predetermined length. The at least one elongated member being substantially hollow for storing at least one preselected item. The at least one elongated member being divided to form at least two separate compartments. There is a cap that is engageable with each respective end of the at least one elongated member for closing each respective end of the at least one elongated member and a handle member engageable with a predetermined portion of the at least one elongated member for carrying the at least one elongated member.

### CROSS REFERENCE TO RELATED APPLICATIONS

This application is closely related to and claims benefit from U.S. Provisional Application Ser. No. 60/663,571 filed Mar. 18, 2005.

The invention taught in this patent application is closely related to the invention taught in the following co-pending patent application, PET TRAVEL TUBES, Ser. No. ______ which is being filed concurrently herewith. These patent applications are assigned to the same assignee and the teachings therein are incorporated into this application by reference thereto.

### FIELD OF THE INVENTION

The present invention relates, in general, to a travel aid and, more particularly, this invention relates to pet travel tubes for carrying items such as water and food for a pet while traveling.

### BACKGROUND OF THE INVENTION

People who travel with their pets or even take them for relatively long walks constantly are faced with the problem of having all of the necessary pet gear available. The needs may be somewhat different for those who are traveling by motorized vehicle for extended or even short trips as opposed to those just going on an extended walk, in that more gear may be necessary for those traveling by vehicles.

However, some of the gear that is required is common to whatever trip the pet will be taking, be it just walking or riding in a vehicle. Items such as water, leashes and waste disposal equipment are always a necessity regardless of how long the trip may be. Extended trips may also require food, toys, treats and other similar items. One problem that the pet owner encounters is that these items are easily misplaced and locating these items before each trip can not only be time consuming but often can be nerve racking. Another problem is where to carry these items while traveling. Placing them in a bag may be inconvenient because the bag may break while in use. Putting these items in a pocket is not possible.

Thus, it would be advantageous if these items could be kept in a convenient location where they would always be together without the need for searching for each item.

### SUMMARY OF THE INVENTION

The present invention provides an apparatus for assisting in one of traveling and taking extended walks with a pet. The apparatus comprises at least one elongated member having each of a predetermined cross section and a predetermined length. The at least one elongated member being substantially hollow for storing at least one preselected item. The at least one elongated member being divided to form at least two separate compartments. There is a first means that is engageable with each respective end of the at least one elongated member for closing each respective end of the at least one elongated member and a second means engageable with a predetermined portion of the at least one elongated member for carrying the at least one elongated member.

### OBJECTS OF THE INVENTION

The present invention provides an apparatus for assisting in one in traveling and taking extended walks with a pet by storing necessary items therein.

Another object of the present invention is to provide an apparatus for carrying items needed for traveling with a pet such as water, food, waste disposal equipment, toys and leashes.

Still another object of the present invention is to provide an apparatus for-carrying items needed for traveling with a pet that is easily carried.

Yet another object of the present invention is to provide an apparatus for carrying items needed for traveling with a pet where the items are secure.

An additional object of the present invention is to provide an apparatus for carrying items needed for traveling with a pet where the caps cans be used as water or food dishes.

In addition to the various objects and advantages of the present invention which have been described in detail above it should be obvious that those persons who are skilled in the relevant art can envision other objects and a advantages of the invention from the following more detailed description of the invention, particularly, when such description is taken in conjunction with the attached drawing Figures and with the appended claims.

### BRIEF DESCRIPTION OF THE DRAWINGS

FIG. 1 is a partial perspective top view of the apparatus according to an embodiment of the invention.

FIG. 2 is a partial perspective bottom view of the apparatus according to the embodiment of the invention shown in FIG. 1.

FIG. 3 is a partial perspective top view of the apparatus according to the embodiment of the invention shown in FIG. 1 with the caps removed and used as dishes.

FIG. 4 is a partial perspective bottom view of the apparatus according to the embodiment of the invention shown in FIG. 1 with the caps removed showing items stored in the compartments.

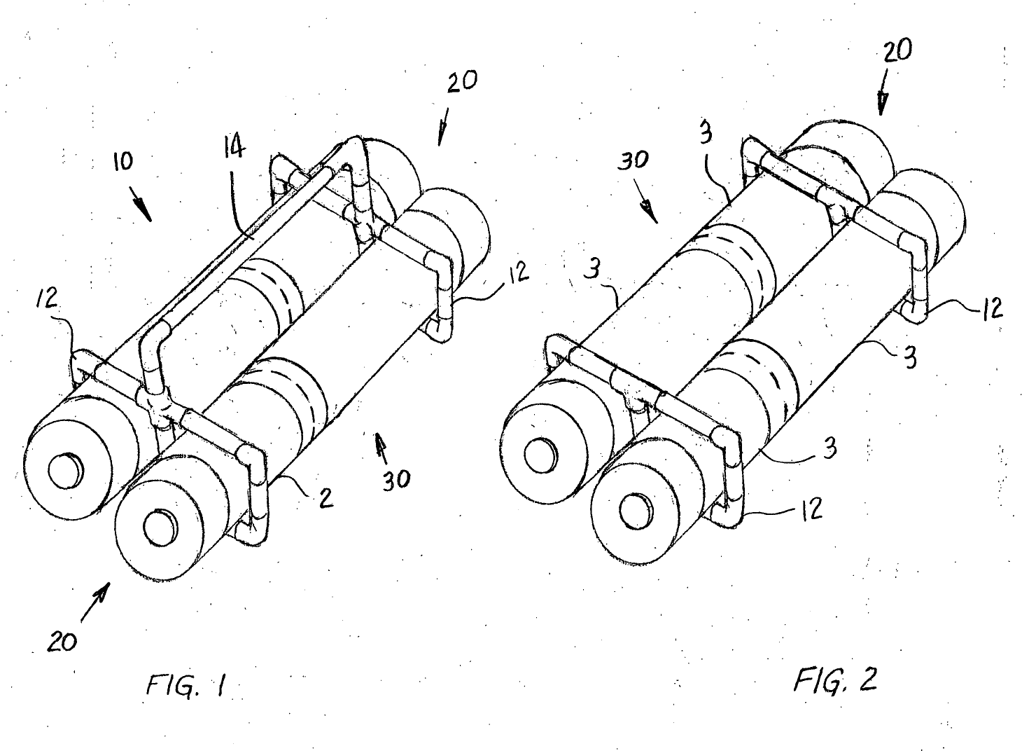

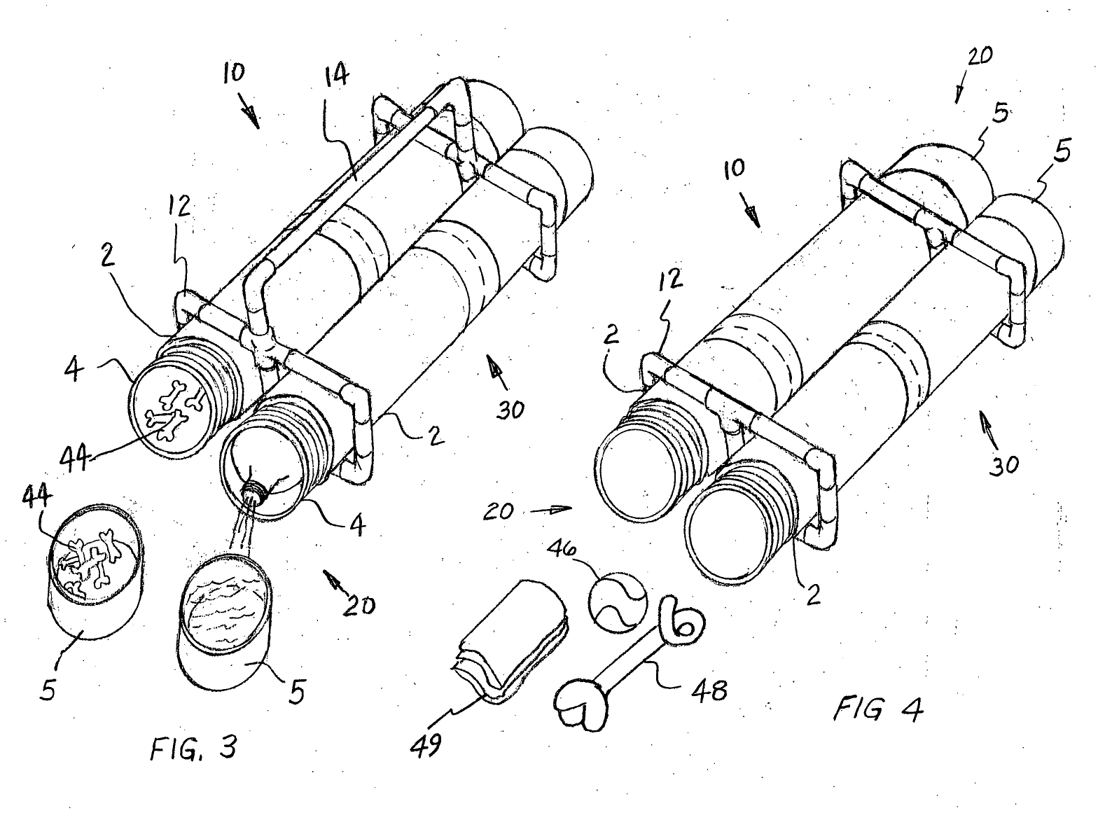

### BRIEF DESCRIPTION OF THE PRESENTLY PREFERRED AND VARIOUS ALTERNATIVE EMBODIMENTS OF THE INVENTION

Prior to proceeding to the more detailed description of the present invention it should be noted that for the sake of clarity and understanding of the invention identical components which have identical reference functions have been identified with identical reference numerals through out the several views illustrated in the drawings.

The present invention provides an apparatus, generally designated 10, for assisting a person in one of traveling with a pet or in taking extended walks with a pet wherein such walk may involve a period of time. The apparatus 10 comprises at least one elongated member 2 having each of a predetermined cross section and a predetermined length. The at least one elongated member 2 being substantially hollow for storing at least one preselected item. The at least one elongated member 2 is divided to form at least two separate compartments 3. There is a first means, generally designated 20, that is engageable with each respective end of the at least one elongated member 2 for closing each respective end of the elongated member 2 and a second means, generally designated 30, that is engageable with a predetermined portion of the elongated member 2 for carrying the elongated member 2.

It is presently preferred that the predetermined cross section of such at least one elongated member is substantially round and that such at least one elongated member 2 be a tube and that further such at least one elongated tube 2 is a pair of elongated tubes 2. As stated it is presently preferred that such predetermined cross section is substantially round, however; it is within the scope of the invention that such cross section be octagonal, hexagonal or any other similar type of cross section.

Each of the pair of elongated members 2 being substantially hollow for storing at least one preselected item, generally designated 40, therein. Each of the pair of elongated members 2 are divided to form at least two separate compartments 3 in each of the pair of elongated members 2. Such elongated tubes 2 are designed to carry such preselected items 40 and that such items include water 42, food and/or treats 44, balls 46, toys 48, leashes and waste disposable bags 49. Further it is preferred that one such compartment 3 in one of the elongated tubes carry water 42, while another compartment 3 is designed to carry waste disposable bags and other waste disposal equipment 49. The compartment 3 in the tube 2 designed to carry water 42 is larger than that compartment 3 that is used for such waste disposal equipment 49. Also it is desired that food and/or treats 44 be stored in one of the other compartments 3. The items stored will be somewhat dependent upon how long the pet will be traveling. If it is just for an extended walk the item could just be treats 44 for the pet; however, if the pet is to travel in a vehicle for a period of time than food 44 for the pet would be desirous.

Such pair of tubes 2 further includes a frame 12 for holding such tubes together and it is preferred that such frame include a carrying handle 14. Also it is an embodiment of the invention that such ends 4 of the tubes 2 be closed by means of a cap 5. Such cap could be affixed to the tube 2 by means of threads or the cap 5 could be a snap on cap 5 or that cap 5 could be held in place by a friction fit. Such caps 5 can be used as a water dish or a food dish. This way the dish is always available.

It is presently preferred that such frame and handle be made of plastic. A variety of plastics may be used, however, it is preferred that such plastic be polyvinyl chloride. It is also preferred that such tubes 2 and caps 5 also be made of plastic.

Beside the preselected items of water, food and waste disposal bags and equipment previously mentioned, some other items that might be carried in such compartments in the tubes 2 would be a ball, toys, leashes and any other favorite item the dog or pet enjoys.

Such tubes 2 can be made in a variety of colors to suit the pet owners needs or desires. The tubes 2 and the caps 16 could be the same color or be made of different colors. Similarly, the frame 12 and handle 14 could also be made of the same color as the tubes or be made of a different color. Also, such tubes could have a design on the exterior surface of the tubes.

While in accordance with the patent statutes a presently preferred embodiment of the invention has been illustrated in the attached drawing figures which have been described above, it should be obvious that various other modifications and alterations can be envisioned by those persons who are skilled in the relevant art without departing from the spirit of the invention.

I claim:

1. An apparatus for assisting in one of traveling and taking extended walks with a pet, said apparatus comprising:
(a) at least one elongated member having each of a predetermined cross section and a predetermined length, said at least one elongated member being substantially hollow for storing at least one preselected item, said at least one elongated member being divided to form at least two separate compartments;
(b) a first means engageable with each respective end of said at least one elongated member for closing said each said respective end of said at least one elongated member; and
(c) a second means engageable with a predetermined portion of said at least one elongated member for carrying said at least one elongated member.

2. The apparatus, according to claim 1, wherein said predetermined cross section of said at least one elongated member is generally round.

3. The apparatus, according to claim 2, wherein said at least one elongated member is an elongated tube.

4. The apparatus, according to claim 2, wherein said at least one elongated member is a pair of elongated tubes.

5. The apparatus, according to claim 1, wherein said at least one preselected item includes water, food, toys, leashes and waste disposable bags,

6. The apparatus, according to claim 5, wherein one compartment of one of said pair of elongated tubes is designed to carry water for such pet.

7. The apparatus, according to claim 6, wherein another compartment of one of said pair of elongated tubes is designed to carry waste disposable bags for such pet.

8. The apparatus, according to claim 7, wherein said compartment designed to carry water is larger than said compartment designed to carry waste disposal bags.

9. The apparatus, according to claim 4, wherein said apparatus further includes a frame for securing said pair of elongated tubes.

10. The apparatus, according to claim 9, wherein said second means includes a carrying handle.

11. The apparatus, according to claim 10, wherein said carrying handle is engageable with said frame.

12. The apparatus, according to claim 1, wherein said first means for closing said elongated tube is a cap.

13. The apparatus, according to claim 12, wherein said cap is secured to said at least one elongated member by at least one of threads, snap on and friction fit.

14. The apparatus, according to claim 1, wherein said at least one elongated member is made of plastic.

15. The apparatus, according to claim 14, wherein said plastic is polyvinylchloride.

16. The apparatus, according to claim 1, wherein said first means and said second means are made of plastic.

17. The apparatus, according to claim 16, wherein said plastic is polyvinylchloride.

18. The apparatus, according to claim 12, wherein said at least one of said cap is used as one of a water dish and a food dish.

19. The apparatus, according to claim 1, wherein said at least one elongated member is made in a variety of colors.

20. The apparatus, according to claim 15, wherein said first means and said second means are made in a variety of colors.
